(19) United States
(12) Patent Application Publication
(10) Pub. No.: US 2018/0334939 A1
(43) Pub. Date: Nov. 22, 2018

(54) ELECTRIC HEATERS COMPRISING CORROSION RESISTANT METALS AND SELECTIVE CATALYTIC REDUCTION DEVICES UTILIZING THE SAME

(71) Applicant: GM GLOBAL TECHNOLOGY OPERATIONS LLC, Detroit, MI (US)

(72) Inventors: Rahul Mital, Rochester Hills, MI (US); Charles Solbrig, Ypsilanti, MI (US); Yong Miao, Ann Arbor, MI (US); David Brown, Commerce Township, MI (US)

(21) Appl. No.: 15/597,636

(22) Filed: May 17, 2017

(51) Int. Cl. F01N 3/20; F01N 3/035; F01N 3/10; C23F 11/00; B01D 53/94; B01J 35/04

(52) U.S. Cl. CPC F01N 3/2066; B01D 2255/502; F01N 3/106; F01N 3/2013; C23F 11/00; B01D 53/9477; B01J 35/04; F01N 2610/10; F01N 2530/02; F01N 2610/02; F01N 2610/1453; B01D 2255/504; B01D 2255/20738; B01D 2255/20746; B01D 2255/20761; B01D 2255/20723; B01D 2255/2027; B01D 2255/2042; B01D 2255/20707; B01D 2255/20776; B01D 2255/20769; B01D 2255/402; B01D 2255/1021; B01D 2255/1023; B01D 2255/1025; B01D 2255/1026; B01D 2255/1028; F01N 3/035

(57) ABSTRACT

Electric heaters comprising corrosion resistant metals (CRM), and exhaust gas treatment systems incorporating the same, are provided. Exhaust gas treatment systems include selective catalytic reduction devices (SCR) disposed downstream from reductant injectors. Electric heaters can be disposed downstream from reductant injectors, and optionally contiguous with or incorporated with a catalytic composition of the SCR. CRMs resist corrosion to reductant, which includes t ammonia and/or nitrogen-rich substances capable of decomposing into ammonia, such as urea. CRMs include aluminum, chromium, iron, and one or more stabilizers. CRMs can include about 5.0% to about 7.25% aluminum, about 15% to about 25% chromium, up to about 0.30% stabilizers, and a balance comprising iron. Stabilizers can include hafnium, yttrium, and zirconium. Stabilizers can include about 0.001% to about 0.11% yttrium and about 0.001% to about 0.11% Hf.

### INTRODUCTION

During a combustion cycle of an internal combustion engine (ICE), air/fuel mixtures are provided to cylinders of the ICE. The air/fuel mixtures are compressed and/or ignited and combusted to provide output torque. After combustion, pistons of the ICE force exhaust gases in the cylinders out through exhaust valve openings and into an exhaust system. The exhaust gas emitted from an ICE, particularly a diesel engine, is a heterogeneous mixture that contains gaseous emissions such as carbon monoxide (CO), unburned hydrocarbons (HC), and oxides of nitrogen (NOx), and oxides of sulfur (SOx) as well as condensed phase materials (liquids and solids) that constitute particulate matter.

Exhaust gas treatment systems may employ catalysts in one or more components configured for accomplishing an after-treatment process such as reducing NOₓ to produce more tolerable exhaust constituents of nitrogen (e.g., N₂) and water. One type of exhaust treatment technology for reducing NOₓ emissions is a selective catalytic reduction device (SCR), which generally includes a catalytic composition capable of reducing NOx species. A reductant, such as urea, is typically sprayed into hot exhaust gases upstream of the SCR, decomposed into ammonia, and absorbed by the SCR device. The ammonia then reduces the NOₓ to nitrogen and water in the presence of the SCR catalyst. Another type of exhaust treatment device is an oxidation catalyst (OC) device, which is commonly positioned upstream from a SCR to serve several catalytic functions, including oxidizing HC and CO species. Further, OCs can convert NO into NO₂ to alter the NO:NOₓ ratio of exhaust gas in order to increase the NOₓ reduction efficiency of the downstream SCR.

### SUMMARY

According to an aspect of an exemplary embodiment, an electrically heated selective catalytic reduction device (SCR) is provided. The SCR can include a shell having an inlet and an outlet, and be configured to receive exhaust gas and reductant via the inlet, a catalyst composition having an upstream side and a downstream side, and an electric heater disposed between the shell inlet and the catalyst composition downstream side. The reductant can include ammonia and/or a nitrogen-rich substance capable of decomposing into ammonia. The SCR can be a selective catalytic filter device.

The SCR catalyst composition can include a washcoat at least partially disposed on the heater outer surface. The electric heater can include a heating element and an outer surface, wherein the outer surface is at least partially disposed within the shell and comprises a corrosion resistant metal (CRM). The CRM can include aluminum, chromium, one or more of hafnium, yttrium, and zirconium, and a balance comprising iron. The CRM can include about 5.25% to about 7.0% aluminum, about 18% to about 23%, chromium, and up to about 0.30% of one or more of hafnium, yttrium, and zirconium. The CRM can include one or more of up to about 0.725% Zr, up to about 0.11% Y, and up to about 0.11% Hf. The CRM further can include one or more of nickel, carbon, nitrogen, sulfur, manganese, silicon, and phosphorous. The CRM further can include one or more of up to about 0.325% nickel, up to about 0.1% carbon, up to about 0.02% nitrogen, up to about 0.035% sulfur, up to about 0.55% manganese, up to about 0.55% silicon, and up to about 0.05% phosphorous.

According to another aspect of an exemplary embodiment, an internal combustion engine (ICE) exhaust gas treatment system is provided. The System can include an ICE configured to emit exhaust gas to an exhaust gas conduit, an oxidation catalyst device (OC) configured to receive exhaust gas from the ICE via the exhaust gas conduit, a selective catalytic reduction device (SCR) disposed downstream from the OC and in fluid communication therewith via the exhaust gas conduit, and including a catalyst composition having an upstream side and a downstream side, a reductant injector configured to inject urea and/or decomposition products thereof into the exhaust gas conduit at a location upstream from the SCR catalyst composition and downstream from the OC, and an electric heater disposed at least partially within the exhaust gas conduit between the reductant injector and the SCR catalyst composition upstream side, wherein the heater includes a heating element and an outer surface and the outer surface comprises a corrosion resistant metal (CRM). The CRM can include up to about 7.5% aluminum, up to about 27.5 chromium, and a balance comprising iron. The CRM can further include about 0.001% to about 0.11% yttrium and about 0.001% to about 0.11% Hf. The CRM can further include about 0.001% to about 0.725% zirconium. The CRM can further include one or more stabilizers consisting essentially of hafnium and yttrium. The CRM can further include one or more stabilizers consisting essentially of zirconium, hafnium, and yttrium. The CRM can include a superficial aluminum oxide layer. The system can further include a turbulator disposed between the reductant injector and the SCR, wherein the outer surface of the heater is in contact with or comprises at least a portion of the turbulator.

According to another aspect of an exemplary embodiment, an exhaust gas treatment system is provided. The system can include a selective catalytic reduction device (SCR) including a catalytic composition disposed within a flow through shell, an exhaust gas conduit in fluid communication with the flow through shell, a reductant injector capable of injecting reductant into the exhaust gas conduit, an electric heater having an outer surface disposed at least partially within the exhaust gas conduit and downstream from the reductant injector. The heater outer surface can include a corrosion resistant metal (CRM) including about 5.0% to about 7.25% aluminum, about 15% to about 25% chromium, up to about 0.30% stabilizers, wherein the one or more stabilizers comprise elements selected from Period 6 elements and/or Group 3 and 4 elements, and a balance comprising iron. The reductant can include urea and/or decomposition products thereof. The balance of the CRM can consist essentially of iron. The CRM can include about 5.25% to about 7.0% aluminum, about 18% to about 23%, chromium. The stabilizers can consist essentially of zirconium, hafnium, and yttrium. The CRM stabilizers can include one or more of up to about 0.725% Zr, up to about 0.11% Y, and up to about 0.11% Hf.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 illustrates an exhaust gas treatment system, according to one or more embodiments;

FIG. 2 illustrates a cross sectional view of an electric heater, according to one or more embodiments; and

FIG. 3 illustrates a perspective view of a selective catalytic reduction device incorporating an electric heater.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Generally, this disclosure pertains to corrosion resistant heaters and their application with selective catalytic reduction devices (SCR) and exhaust gas treatment systems incorporating the same. The heaters allow for improved performance of SCRs and improved emissions for appurtenant vehicles, for example. The exhaust gas treatment systems described herein can be implemented in various ICE systems that can include, but are not limited to, diesel engine systems, gasoline direct injection systems, and homogeneous charge compression ignition engine systems. The ICEs will be described herein for use in generating torque for vehicles, yet other non-vehicular applications are within the scope of this disclosure. Therefore when reference is made to a vehicle, such disclosure should be interpreted as applicable to any application of an ICE. Moreover, exhaust gas treatment systems are described in combination with an optional ICE for the purposes of illustration only, and the disclosure herein is not to be limited to gas sources provided by ICEs. It should be further understood that the embodiments disclosed herein may be applicable to treatment of any exhaust streams including oxides of nitrogen (NOₓ) or other chemical species which are desirably reduced by SCRs.

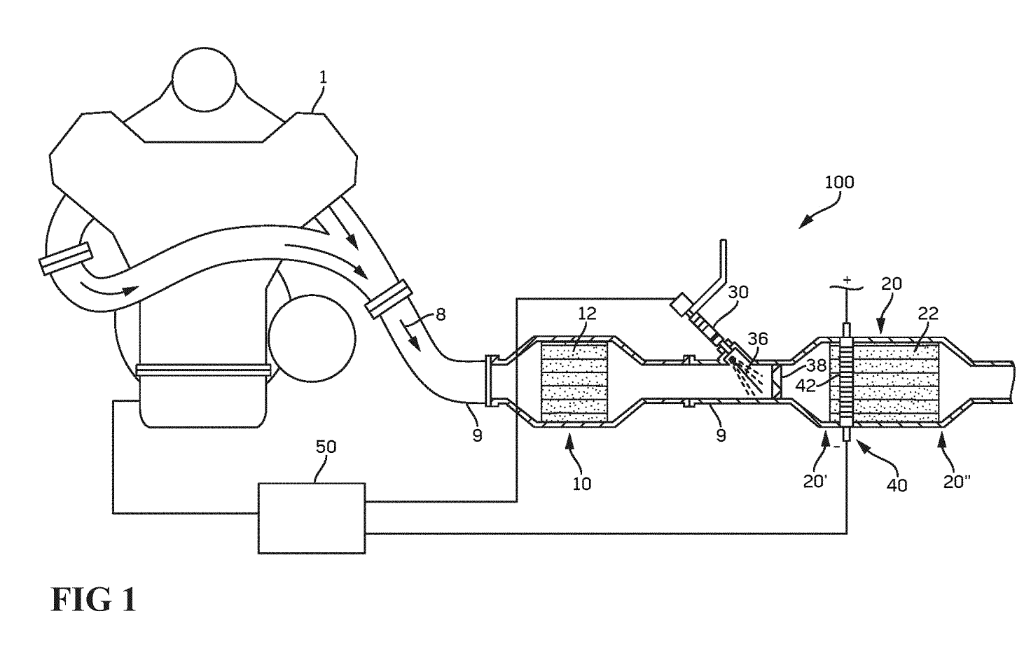

FIG. 1 illustrates an exhaust gas treatment system 100 including an SCR 20 configured to receive exhaust gas 8 via exhaust gas conduit 9, and reductant 36 via injector 30. System 100 further includes a heater 40 appurtenant to and/or integrated with SCR 20. Exhaust gas 8 can he generated and communicated by ICE 1, for example. System 100 can further optionally include an oxidation catalyst device (OC) 10 configured to receive exhaust gas 8. OC 10 is illustrated in a position upstream relative from SCR, but other configures are practicable and within the scope of this disclosure. As used herein, “upstream” and “downstream” can be defined in relation to the direction of the flow of exhaust gas 8 from ICE 1; accordingly, a component located upstream relative to a downstream component generally means that it is relatively closer to ICE 1 or that exhaust gas 8 arrives at the upstream component prior to the downstream component.

ICE 1 can include one or more cylinders (not shown) capable of each accepting a piston (not shown) which can reciprocate therein. Air and fuel are combusted in the one or more cylinders thereby reciprocating the appurtenant pistons therein. The pistons can be attached to a crankshaft (not shown) operably attached to a vehicle driveline (not shown) in order to deliver tractive torque thereto, for example. ICE 1 can comprise any engine configuration or application, including various vehicular applications (e.g., automotive, marine and the like), as well as various non-vehicular applications (e.g., pumps, generators and the like).

Exhaust gas 8 can generally include carbon monoxide (CO), unburned hydrocarbons (HC), water, NOx species, and optionally oxides of sulfur (SOx). Constituents of exhaust gas, as used herein, are not limited to gaseous species. As used herein, “NOₓ” refers to one or more nitrogen oxides. NOₓ species can include N_{y}Oₓ species, wherein y>0 and x>0. Non-limiting examples of nitrogen oxides can include NO, NO₂, N₂O, N₂O₂, N₂O₃, N₂O₄, and N₂O₅. HC refers to combustable chemical species comprising hydrogen and carbon, and generally includes one or more chemical species of gasoline, diesel fuel, or the like.

System 100 can further include a control module 50 operably connected to monitor and/or control ICE 1, OC 10, SCR 20, injector 30, heater 40, and combinations thereof. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality. Module 50 can control the selective use of heater 40, for example.

In general, the SCR 20 includes all devices which utilize a reductant 36 and a catalyst to reduce NOx species to desired chemical species, including diatomic nitrogen, nitrogen-containing inert species, or species which are considered acceptable emissions, for example. The reductant 36 can be ammonia (NH₃), such as anhydrous ammonia or aqueous ammonia, or generated from a nitrogen and hydrogen rich substance such as urea (CO(NH₂)₂) which is capable of decomposing into NH₃. Additionally or alternatively, the reductant 36 can be any compound capable of decomposing or reacting in the presence of exhaust gas 8 and/or heat to form ammonia. The reductant 36 can be diluted with water in various implementations. In implementations where the reductant 36 is diluted with water, heat (e.g., from the exhaust) evaporates the water, and ammonia is supplied to the SCR 20. Non-ammonia reductants can be used as a full or partial alternative to ammonia as desired. In implementations where the reductant 36 includes urea, the urea reacts with the exhaust to produce ammonia, and ammonia is supplied to the SCR 20. Equation (1) below provides an exemplary chemical reaction of ammonia production via urea decomposition.

CO(NH₂)₂+H₂O→2NH₃+CO₂ (1)

It should be appreciated that Equation (1) is merely illustrative, and is not meant to confine the urea or other reductant 36 decomposition to a particular single mechanism, nor preclude the operation of other mechanisms. Efficient decomposition urea to NH₃ typically requires temperatures in excess of about 200° C., and, depending on the amount of urea injected, for example relative to a flow rate of exhaust gas 8, urea can crystalize in temperatures less than about 200° C. Accordingly, reductant 36 injection events and/or dosing quantities are typically determined based upon system temperature and exhaust gas 8 flow rate, among others, such that urea decomposition yield is maximized and urea crystallization is minimized.

Equations (2)-(6) provide exemplary chemical reactions for NOₓ reduction involving ammonia.

6NO+4NH₃→5N₂+6H₂O (2)

4NO+4NH₃+O₂→4N₂+6H₂O (3)

6NO₂+8NH₃→7N₂+12H₂O (4)

2NO₂+4NH₃+O₂→3N₂+6H₂O (5)

NO+NO₂+2NH₃→2N₂+3H₂O (6)

It should be appreciated that Equations (2)-(6) are merely illustrative, and are not meant to confine SCR 20 to a particular NOₓ reduction mechanism or mechanisms, nor preclude the operation of other mechanisms. SCR 20 can be configured to perform any one of the above NOₓ reduction reactions, combinations of the above NOₓ reduction reactions, and other NOₓ reduction reactions.

As shown in FIG. 1, SCR 20 includes a catalytic composition (CC) 22 packaged in a shell or canister generally defining an upstream side 20′ (i.e., inlet) and a downstream side 20″ (i.e., outlet) and disposed in fluid communication with exhaust gas conduit 9 and optionally other exhaust treatment devices (e.g., OC 10). The shell or canister can comprise a substantially inert material, relative to the exhaust gas constituents, such as stainless steel. SCR 20 is configured to receive exhaust gas 8 and reductant 36 at upstream side 20′. Reductant 36 can be supplied from a reductant reservoir (not shown) and injected into the exhaust gas conduit 9 at a location upstream from SCR 20 via an injector 30, or other suitable delivery means. Reductant 36 can be in the form of a gas, a liquid, or an aqueous solution, such as an aqueous urea solution. Reductant 36 can be mixed with air in the injector 30 to aid in the dispersion of the injected spray. A turbulator 38 (i.e., mixer) can also be disposed within the exhaust conduit 9 in close proximity to the injector 30 and/or the SCR 20 to further assist in thorough mixing of reductant 36 with the exhaust gas 8 and/or even distribution throughout the SCR 20, and particularly throughout CC 22. Turbulator 38 can comprise a fixed or movable body configured to mix, vaporize, and/or otherwise contact reductant 36 within conduit 9. For example, turbulator 38 can comprise a rotating body including one or a plurality of vanes. Turbulator 38 can comprise a metal or electrically conductive material.

CC 22 can be a porous and high surface area material which can operate efficiently to convert NOₓ constituents in the exhaust gas 8 in the presence of a reductant 36, such as ammonia. For example, the catalyst composition can contain a zeolite impregnated with one or more base metal components such as iron (Fe), cobalt (Co), copper (Cu), vanadium (V), sodium (Na), barium (Ba), titanium (Ti), tungsten (W), and combinations thereof. In a particular embodiment, the catalyst composition can contain a zeolite impregnated with one or more of copper, iron, or vanadium. In some embodiments the zeolite can be a β-type zeolite, a Y-type zeolite, a ZM5 zeolite, or any other crystalline zeolite structure such as a Chabazite or a USY (ultra-stable Y-type) zeolite. In a particular embodiment, the zeolite comprises Chabazite. In a particular embodiment, the zeolite comprises SSZ. Suitable CCs 22 can have high thermal structural stability, particularly when used in tandem with particulate filter (PF) devices or when incorporated into selective catalytic reduction filter devices (SCRF), which are regenerated via high temperature exhaust soot burning techniques. CC 22 can optionally further comprise one or more base metal oxides as promoters to further decrease the SO₃ formation and to extend catalyst life. The one or more base metal oxides can include WO₃, Al₂O₃, and MoO₃, in some embodiments. In one embodiment, WO₃, Al₂O₃, and MoO₃ can be used in combination with V₂O₅.

SCR 20 can have a light-off temperature above which CC 22 exhibits desired or suitable catalytic activity or yield (e.g., reduction of NOx species). The light-off temperature can be dependent upon the type of catalytic materials of which CC 22 is comprised, and the amount of catalytic materials present in SCR 20, among other factors. For example, a CC 22 comprising V₂O₅ can have a light off temperature of about 300° C. In another example, a CC 22 comprising Fe-impregnated zeolite can have a light off temperature of about 350° C. In another example, a CC 22 comprising Cu-impregnated zeolite can have a light off temperature of about 150° C. When SCR 20 operates at a temperature below its light-off temperature, undesired NOₓ breakthrough and NH₃ slip can occur wherein NOₓ and/or NH₃ pass through SCR 20 unreacted or unstored. NOₓ breakthrough and NH₃ slip can be particularly problematic immediately after engine startup and in cold conditions. NOₓ breakthrough can also be exacerbated by lean burn strategies commonly implemented in diesel engines, for example. Lean burn strategies coordinate combustion at higher than stoichiometric air to fuel mass ratios to improve fuel economy, and produce hot exhaust with a relatively high content of O2 and NOₓ species. The high O2 content can further inhibit or prevent the reduction of NOₓ species in some scenarios.

CC 22 can be disposed on a substrate body, such as a metal or ceramic brick, plate, or monolithic honeycomb structure. CC 22 can be deposited on the substrate body as a washcoat, for example. A monolithic honeycomb structure can include several hundred to several thousand parallel flow-through cells per square inch, although other configurations are suitable. Each of the flow-through cells can be defined by a wall surface on which CC 22 can be washcoated. The substrate body can be formed from a material capable of withstanding the temperatures and chemical environment associated with the exhaust gas 8. Some specific examples of materials that can be used include ceramics such as extruded cordierite, α-alumina, silicon carbide, silicon nitride, zirconia, mullite, spodumene, alumina-silica-magnesia, zirconium silicate, sillimanite, petalite, or a heat and corrosion resistant metal such as titanium or stainless steel. The substrate can comprise a non-sulfating TiO₂ material, for example. The substrate body can comprise, be contiguous with, or be proximate heater 40, as will be described below. One example of an exhaust gas treatment device is a SCRF which provide the catalytic aspects of SCRs in addition to particulate filtering capabilities. Generally, an SCRF comprises CC 22 applied to a filter substrate, such as a ceramic or SiC wall flow monolith filter, wound or packed fiber filters, open cell foams, sintered metal fibers, etc. In some embodiments, the SCRF filter substrate can comprise, be contiguous with, or be proximate heater 40, as will be described below.

Optional OC 10 is a flow-through device comprising a catalytic composition (CC) 12 and configured to accept exhaust gas 8. OC 10 is generally utilized to oxidize various exhaust gas 8 species, including HC, CO, and NOₓ species. CC 12 can be housed within a housing, such as a metal housing, having an inlet (i.e., upstream) opening and outlet (i.e., downstream) opening, or be otherwise configured to provide structural support and facilitate fluid (e.g., exhaust gas) flow through OC 10. The housing can ideally comprise a substantially inert material, relative to the exhaust gas constituents, such as stainless steel, and may comprise any suitable shape or size including a cylindrically shaped compartment. The compartment further may include attachment features, such as a cylindrical inlet pipe located proximate an inlet opening and a cylindrical outlet pipe located proximate an outlet opening of the compartment for fluid coupling of OC 10 to exhaust gas conduit 9 and/or another component of the exhaust gas treatment system 100. It should be appreciated that OC 10, including the housing, can include one or more additional components for facilitating in operation of the OC 10, or exhaust gas treatment system. 100, including, but not limited to, various sensors.

CC 12 can comprise many various catalytically active materials and physical configurations thereof, and can optionally comprise a substrate such as a porous ceramic matrix or the like. Catalytically active materials can comprise platinum group metal catalysts, metal oxide catalysts, and combinations thereof. Suitable platinum group metals can include Pt, Pd, Rh, Ru, Os or Ir, or combinations thereof, including alloys thereof. In one embodiment, suitable metals include Pd, and combinations thereof, including alloys thereof. Suitable metal oxide catalyst can include iron oxides, zinc oxides, aluminum oxides, perovksites, and combination thereof, for example. In one embodiment, CC 12 can comprise Pt and Al₂O₃. In many embodiments, CC 12 comprises zeolite impregnated with one or more catalytically active base metal components. The zeolite can comprise a β-type zeolite, a Y-type zeolite, a ZM5 zeolite, or any other crystalline zeolite structure such as a Chabazite or a USY (ultra-stable Y-type) zeolite. In a particular embodiment, the zeolite comprises Chabazite. In a particular embodiment, the zeolite comprises SSZ. It is to be understood that the CC 12 is not limited to the particular examples provided, and can include any catalytically active device capable of oxidizing HC, CO, and NOx species.

OC 10 can store and/or oxidize NOx species in exhaust gas 8, which, for example, may form during the combustion of fuel. For example, in some embodiments, OC 10 can be utilized to convert NO into NO₂ in order to optimize the exhaust gas NO:NO₂ ratio for downstream SCRs and/or SCRFs which generally operate more efficiently with exhaust gas feed streams having a NO:NO₂ ratio of about 1:1. Accordingly, in many embodiments, OC 10 is disposed upstream from optional SCRs and SCRF devices. OC 10 can have a light-off temperature above which CC 12 exhibits desired or suitable catalytic activity relating to the oxidation of NOx species. An OC 10 NOx oxidation light-off temperature can also correspond to the temperature at which NOx species stored by CC 12 are released. The light-off temperature can be dependent upon the type of catalytic materials of which CC 12 is comprised, and the amount of catalytic materials present in OC 10, among other factors. Generally, CC 12 can have a NOx oxidation light off temperature of about 150° C. to about 200° C. For example, some CCs 12 achieve 50% conversion of NOx species at about 230° C. When OC 10 operates at a temperature below its NOx oxidation light-off temperature, the NO₂:NOx ratio of exhaust gas 8 communicated from OC 10 to a downstream SCR 20 is not optimized.

OC 10 can additionally or alternatively store HC and/or catalyze the oxidation (e.g., combustion) of HC and CO species in exhaust gas. Combustion generally involves the oxidation of HC and/or CO species in the presence of oxygen to generate heat, water, and CO₂. In some instances, HC and/or CO may be present in exhaust gas 8 as a consequence of undesired incomplete combustion of fuel 6, for example. In other instances, HC may be present in exhaust gas 8 in order to implement various ICE 1 and/or system 100 control strategies. For example, exothermic oxidation of HC can OC 10 can be utilized to oxidize HC to provide heat to system 100 to aid one or more exhaust gas treatment devices achieve light-off temperatures. OC 10 can additionally or alternatively be utilized to oxidize HC for after-injection and auxiliary-injection regeneration strategies. After-injection strategies, such as those used for regeneration of PFs and/or catalysts, manipulate engine calibrations such that fuel 6 after-injected into the engine cylinders is expelled into the exhaust system 100 at least partially uncombusted. When the after-injected fuel 6 contacts OC 10, heat released during oxidation of the fuel 6 is imparted to the exhaust gas treatment system and can aid in regenerating various treatment devices, such as particular filter PFs and SCRFs, for example. Similarly, auxiliary-injection strategies, such as those used for regeneration of PFs and/or catalysts, inject fuel into system 100 downstream from ICE 1 in order to contact the fuel with OC 10.

OC 10 can have a light-off temperature above which CC 12 exhibits desired or suitable catalytic activity relating to the oxidation of CO and/or HC species. An OC 10 CO and/or HC light-off temperature can also correspond to the temperature at which CO and/or HC species stored by CC 12 are released. The light-off temperature can be dependent upon the type of catalytic materials of which CC 12 is comprised, and the amount of catalytic materials present in OC 10, among other factors. Generally, CC 12 can have a CO oxidation light off temperature of about 150° C. to about 175° C. For example, some CCs 12 achieve 50% conversion of NOx species at about 200° C. Generally, CC 12 can have a HC oxidation light off temperature of about 175° C. to about 250° C. For example, some CCs 12 achieve 50% conversion of NOx species at about 275° C. When OC 10 operates at a temperature below its CO and/or HC oxidation light-off temperature, undesired CO and/or HC breakthrough can occur.

Exhaust gas treatment systems can further include heaters, such as electric heaters, to assist one or more exhaust gas treatment devices (e.g., OC, SCR) achieve and/or maintain light-off temperatures, for example. Heaters are commonly employed upstream from, or integrated with OCs, however, heating an OC positioned upstream from an SCR can desorb NOx stored in the OC prior to the SCR reaching its NOx light-off temperature and cause NOx breakthrough. Further, reductant can be corrosive to heaters. Provided herein are heaters 40, and exhaust gas treatment systems 100 incorporating the same, which exhibit corrosion resistance to reductant 36, and can be disposed downstream from reductant injectors 30 in a number of locations effective to heat SCR 20 and/or reductant 36. Heaters 40 may be controlled to effect a desired temperature for decomposition of reductant 36. Additionally or alternatively heater 40 may be controlled to provide a desired temperature for operation (e.g., NOx species reduction) of CC 22. The desired CC 22 temperature may be in a temperature range where performance of CC 22 is optimal, or in a temperature range where reduction of NOx is above a desired level. Desired temperatures can depend upon the type and amount of catalytic material within SCR 20, for example. Such heaters assist SCRs in more quickly achieving light-off temperatures and increase NOx conversion earlier in an ICE operating window, for example after a cold start. Further, heaters 40 assist in reductant 36 heating and decomposition, allow reductant 36 to be injected sooner in an ICE 1 operating cycle, and eliminate or reduce reductant 36 crystallization, for example.

Heater 40 can be selectively activated and deactivated. Heater 40 can be operatively connected to and controlled by module 50. Heater 40 can be controlled to implement a thermal management control routine of ICE 1, for example. Module 50 may also control heater 40 to supplement ICE 1 thermal management of CC 22 temperature, thereby reducing engine wear. Heater 40 can operate at a range of voltages, for example from about 12 volts to about 48 volts, and over a range of powers, for example about 1 kilowatt to about 10 kilowatts. One of skill in the art will understand that other operating voltages and powers are within the scope of this disclosure. Heater is capable of reaching temperature of about 200° C. to about 1000° C.

In general, heater 40 comprises a heating element 42 through which electric current is directed in order to generate heat (e.g., via Joule heating and/or via induction heating). FIG. 1 illustrates a heater 40 disposed downstream from injector 30. Heater 40 comprises a corrosion resistant metal (CRM) as will be described below, such that corrosion induced by reductant 36 is prevented or minimized. Heater 40 can be disposed downstream from injector 30 and upstream from SCR 20 downstream end 20″. Heater 40 can be disposed contiguous with CC 22. Heater 40 can be positioned proximate the upstream side of CC 22. Heater 40 comprises an outer surface in fluid communication with SCR 20 and/or exhaust gas conduit 9 proximate injector 30 and/or SCR 20. Heater 40 outer surface comprises a CRM.

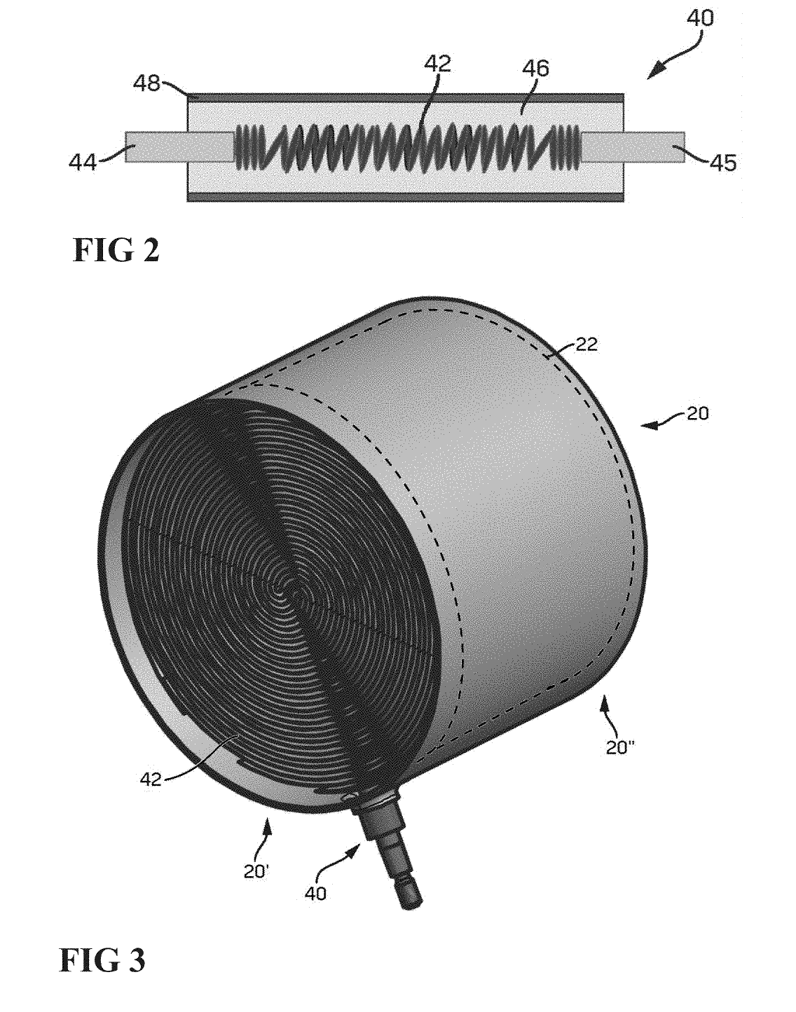

FIG. 2 illustrates a cross-sectional view of one embodiment of heater 40, comprising heating element 42. Cold pins 44 and 45 transmit current across heating element 42 from a power source (not shown) in order to generate heat. In such an embodiment, heating element 42 can comprise the outer surface of heater 40 and accordingly can comprise a CRM. In some embodiments, heating element 42 consists essentially of a CRM. Optionally, heating element 42 can be encased in sheath 48 capable of isolating heating element 42 from external environments. Specifically, sheath 48 is capable of isolating heating element 42 from exhaust gas 8 and reductant 36. In such embodiments, sheath 48 can comprise the outer surface and accordingly can comprise a CRM. Heating element 42 can then comprise any suitable material that is electrically conductive, and need not necessarily comprise a CRM. In some embodiments, sheath 48 consists essentially of a CRM. Heater 40 may optionally include packing 46 in combination with sheath 48, wherein packing 46 is capable of transferring heat between heating element 42 and sheath 48. Packing 46 can be solid or porous, for example. Packing 46 can comprise magnesium oxide, in some embodiments.

Heater 40 can be a standalone element, or can be integrated into one or more aspects of SCR 20 or system 100. For example, in some embodiments SCR 20 can comprise a metal substrate onto which CC 22 is deposited (e.g., washcoated). In such an embodiment, heating element 42, or optional sheath 48, can comprise, or be in electrical communication with, the metal substrate. In such embodiments, heater 40 can be biased towards an upstream side of CC 22. In some embodiments, heating element 42, or optional sheath 48, can comprise, or be in electrical communication with, turbulator 38. Heating element 42 can comprise any shape or orientation suitable for transmitting heat to one or more of exhaust gas 8 and reductant 36 while allowing suitable flow of the same therepast. For example, heating element 42 can comprise a metal foil, wire, or plate. Heating element 42 can comprise a wire coil, in some embodiments. FIG. 3 illustrates a perspective view of SCR 20 paired with heater 40. Heating element 42 is coiled to form a circular cross-sectional shape which generally corresponds to inner contour of SCR 20. As shown, heating element 42 is positioned upstream from CC 22.

The CRMs of the present disclosure are designed to provide features such corrosion resistance, particularly at high temperatures. Generally, the CRMs described herein will be defined as a percentage (by weight) of one or more alloying elements or compounds with the balance of the CRM comprising iron (Fe), substantially comprising Fe, or consisting essentially of Fe. In some embodiments the disclosed Alloying elements or compounds include a normal degree of industry-standard impurity (e.g., 99.9% purity).

The CRMs provided herein comprise Fe, aluminum (Al), chromium (Cr), and optionally one or more alloying elements or compounds. A CRM can include Fe in one or more microstructures, including ferrite, pearlite, bainite and martensite. In some embodiments, the CRM microstructures substantially comprise ferrite. In some embodiments, the CRM microstructures consist essentially of ferrite. In some embodiments, the CRMs can comprise up to about 20%, up to about 22.5%, up to about 25%, or up to about 27.5% Cr. In some embodiments, the CRMs can comprise about 15% to about 25%, about 18% to about 23%, or about 19% to about 22% Cr. In some embodiments, Cr can be present in its elemental form. Additionally or alternatively, Cr can be present as a compound. In some embodiments, the CRMs can comprise up to about 6.5%, up to about 7.0%, or up to about 7.5% Al. In some embodiments. the CRMs can comprise about 5.0% to about 7.25%, about 5.25% to about 7.0%, or about 5.5% to about 6.75% Al. In some embodiments, Al can be present in its elemental form. Additionally or alternatively, Al can be present as a compound. Al compounds can include aluminum nitrides, such as AlN, Al₂O₃, Al₃P, Al₃Ti, and AlFeSi, among others. Al in the CRM can further oxidize and form a superficial aluminum oxide layer on the CRM surface which provides corrosion resistance. The aluminum oxide layer can comprise AL₂O₃.

The CRMs can optionally further comprise one or more stabilizers in order to stabilize the aluminum oxide layer and provider enhanced adhesion thereof to the CRM. The stabilizers can comprise one or more Period 6 elements. Period 6 elements can include barium (Ba), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), hafnium (Hf), tantalum (Ta), tungsten (W), rhenium (Re), osmium (Os), and iridium (Ir). The stabilizers can comprise one or more elements from Periodic Groups 3 and 4. Periodic Groups 3 and 4 elements can include scandium (Sc), titanium (Ti), yttrium (Y), zirconium (Zr), Ba, La, Ce, Pr, Nd, Pm, Sm, Eu, Gd, Tb, Dy, Ho, Er, Tm, Yb, Lu, and Hf. In some embodiments, stabilizers can include one or more of Y, Zr, and Hf. CRMs can comprise up to about 0.2%, up to about 0.25%, or up to about 0.30% stabilizers. In one embodiment, a CRM can comprise up to about 0.27%, or up to about 0.28% stabilizers, wherein the stabilizers comprise Zr, Y, and Hf. In one embodiment, the stabilizers consist of Y and Hf. In one embodiment, the stabilizers consist essentially of Y and Hf. In one embodiment, the stabilizers consist of Zr, Y, and Hf. In one embodiment, the stabilizers consist essentially of Zr, Y, and Hf.

A CRM can comprise up to about 0.675%, up to about 0.7%, or up to about 0.725% Zr. A CRM can comprise about 0.001% to about 0.675%, about 0.001% to about 0.7%, or about 0.001% to about 0.725% Zr. Zr can act as a deoxidizer, increase CRM strength, and limit grain size, for example. Additionally or alternatively, a CRM can comprise up to about 0.09%, up to about 0.1%, or up to about 0.11% Y. A CRM can comprise about 0.001% to about 0.09%, about 0.001% to about 0.1%, or about 0.001% to about 0.11% Y. Additionally or alternatively, a CRM can comprise up to about 0.09%, up to about 0.1%, or up to about 0.11% Hf. A CRM can comprise about 0.001% to about 0.09%, about 0.001% to about 0.1%, or about 0.001% to about 0.11% Hf.

A CRM can optionally further comprise nickel (Ni). Ni can increase CRM strength, impact resistance, and toughness, and can improve resistance to oxidation and corrosion. A CRM can comprise up to about 0.275%, up to about 0.30%, or up to about 0.325% Ni. In some embodiments, the CRMs can comprise about 0.001% to about 0.275%, about 0.001% to about 0.30%, or about 0.001% to about 0.325% Ni.

A CRM can optionally further comprise carbon (C). C can increase CRM hardness, strength, and wear resistance. A CRM can comprise up to about 0.04%, up to about 0.05%, up to about 0.075%, or up to about 0.1% C. In some embodiments, the CRMs can comprise about 0.001% to about 0.05%, about 0.001% to about 0.075%, or about 0.001% to about 0.1% C. A CRM can optionally further comprise nitrogen (N), which can form nitrides in the CRM. A CRM can include up to about 0.01% or up to about 0.02% N. N can be included to facilitate the formation of AlN and/or TiN, for example. N can be used to improve stength, for example. A CRM comprising C and N can further comprise Nb and Ti stabilizers. The amount of Nb and Ti can collectively be greater than 0.20% +4(C %+N %). In some embodiments. Ti can be present in its elemental form. Additionally or alternatively, Ti can be present as a compound. Ti compounds can include titanium nitrides, such as TiN, Al₃Ti, TiC, Ti₄C₂S₂, and Ti₃O₅, among others.

In some embodiments, the CRM can optionally further comprise sulfur. A CRM can comprise up to about 0.035%, up to about 0.03%, or up to about 0.025% S. In some embodiments, the CRMs can comprise about 0.0001% to about 0.035%, about 0.0001% to about 0.03%, or about 0.0001% to about 0.025% S. In some embodiments, S can be present in its elemental form. Additionally or alternatively, S can be present as a compound. S compounds can include manganese sulfides (e.g., MnS and MnS₂), iron sulfides (e.g., FeS, FeS₂, Fe₂S₃, Fe₃S₄, and Fe₇S₈), and H₂S, among others. In some embodiments, sulfur compounds can additionally or alternatively comprise sulfides of Zinc (Zn).

In some embodiments, the CRM optionally further comprise manganese (Mn). A CRM can comprise up to about 0.45%, up to about 0.5%, or up to about 0.55% Mn. In some embodiments, the CRMs can comprise about 0.001% to about 0.45%, about 0.001% to about 0.5%, or about 0.001% to about 0.55% Mn. Mn can act as a deoxidizer. In some embodiments, Mn can be present in its elemental form. Additionally or alternatively, Mn can be present as a compound. CRMs comprising Mn and S can include manganese sulfide compounds, such as MnS and MnS₂, among others.

In some embodiments, the CRM can optionally further comprise silicon (Si). A CRM can comprise up to about 0.45%, up to about 0.5%, or up to about 0.55% Si. In some embodiments, the CRMs can comprise about 0.001% to about 0.45%, about 0.001% to about 0.5%, or about 0.001% to about 0.55% Si. Si can act as a deoxidizer. In some embodiments, Si can be present in its elemental form. In one example elemental Si can be dissolved within ferrite to enhance strength. Additionally or alternatively, Si can be present as a compound.

In some embodiments, the CRM can optionally further comprise phosphorus (P). A CRM can comprise up to about 0.05%, up to about 0.045%, or up to about 0.04% P. In some embodiments, the CRMs can comprise about 0.0001% to about 0.04%, about 0.0001% to about 0.045%, or about 0.0001% to about 0.05% P. In some embodiments, P can be present in its elemental form. Additionally or alternatively, P can be present as a compound. P compounds can include phosphides, such as iron phosphides PO₂, and Al₃P, among others. In one example, P compounds within the CRM can include steadite.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An electrically heated selective catalytic reduction device (SCR), comprising:
a shell having an inlet and an outlet, and be configured to receive exhaust gas and reductant via the inlet;
a catalyst composition having an upstream side and a downstream side; and
an electric heater disposed between the shell inlet and the catalyst composition downstream side, wherein the electric heater includes a heating element and an outer surface, and the outer surface is at least partially disposed within the shell and comprises a corrosion resistant metal (CRM) including aluminum, chromium, one or more of hafnium, yttrium, and zirconium, and a balance comprising iron.

2. The electrically heated SCR of claim 1, wherein the catalyst composition comprises a washcoat at least partially disposed on the heater outer surface.

3. The electrically heated SCR of claim 1, wherein the reductant comprises ammonia and/or a nitrogen-rich substance capable of decomposing into ammonia.

4. The electrically heated SCR of claim 1, wherein the SCR comprises a selective catalytic filter device.

5. The electrically heated SCR of claim 1, wherein the CRM includes about 5.25% to about 7.0% aluminum, about 18% to about 23%, chromium, and up to about 0.30% of one or more of hafnium, yttrium, and zirconium.

6. The electrically heated SCR of claim 1, wherein the CRM includes one or more of up to about 0.725% zirconium, up to about 0.11% yttrium, and up to about 0.11% hafnium.

7. The electrically heated SCR of claim 1, wherein the CRM further comprises one or more of nickel, carbon, nitrogen, sulfur, manganese, silicon, and phosphorous.

8. The electrically heated SCR of claim 1, wherein the CRM further comprises one or more of up to about 0.325% nickel, up to about 0.1% carbon, up to about 0.02% nitrogen, up to about 0.035% sulfur, up to about 0.55% manganese, up to about 0.55% silicon, and up to about 0.05% phosphorous.

9. An internal combustion engine (ICE) exhaust gas treatment system, including
an ICE configured to emit exhaust gas to an exhaust gas conduit;
an oxidation catalyst device (OC) configured to receive exhaust gas from the ICE via the exhaust gas conduit;
a selective catalytic reduction device (SCR) disposed downstream from the OC and in fluid communication therewith via the exhaust gas conduit, and including a catalyst composition having an upstream side and a downstream side;
a reductant injector configured to inject urea and/or decomposition products thereof into the exhaust gas conduit at a location upstream from the SCR catalyst composition and downstream from the OC; and
an electric heater disposed at least partially within the exhaust gas conduit between the reductant injector and the SCR catalyst composition upstream side, wherein the heater includes a heating element and an outer surface and the outer surface comprises a corrosion resistant metal (CRM) including up to about 7.5% aluminum, up to about 27.5 chromium, and a balance comprising iron.

10. The ICE exhaust gas treatment system of claim 9, wherein the CRM further comprises about 0.001% to about 0.11% yttrium and about 0.001% to about 0.11% hafnium.

11. The ICE exhaust gas treatment system of claim 10, wherein the CRM further comprises about 0.001% to about 0.725% zirconium.

12. The ICE exhaust gas treatment system of claim 9, wherein the CRM further comprises one or more stabilizers consisting essentially of hafnium and yttrium.

13. The ICE exhaust gas treatment system of claim 9, wherein the CRM further comprises one or more stabilizers consisting essentially of zirconium, hafnium, and yttrium.

14. The ICE exhaust gas treatment system of claim 9, wherein the CRM comprises a superficial aluminum oxide layer.

15. The ICE exhaust gas treatment system of claim 9, further comprises a turbulator disposed between the reductant injector and the SCR, wherein the outer surface of the heater is in contact with or comprises at least a portion of the turbulator.

16. An exhaust gas treatment system comprising:
a selective catalytic reduction device (SCR) including a catalytic composition disposed within a flow through shell;
an exhaust gas conduit in fluid communication with the flow through shell;
a reductant injector capable of injecting reductant into the exhaust gas conduit, wherein the reductant comprises urea and/or decomposition products thereof; and
an electric heater having an outer surface disposed at least partially within the exhaust gas conduit and downstream from the reductant injector, wherein the outer surface comprises a corrosion resistant metal (CRM) including about 5.0% to about 7.25% aluminum, about 15% to about 25% chromium, up to about 0.30% stabilizers, wherein the one or more stabilizers comprise elements selected from Period 6 elements and/or Group 3 and 4 elements, and a balance comprising iron.

17. The exhaust gas treatment system of claim 16, wherein the balance of the CRM consists essentially of iron.

18. The exhaust gas treatment system of claim 16, wherein the CRM comprises about 5.25% to about 7.0% aluminum, about 18% to about 23%, chromium.

19. The exhaust gas treatment system of claim 16, wherein the stabilizers consist essentially of zirconium, hafnium, and yttrium.

20. The exhaust gas treatment system of claim 16, wherein the CRM stabilizers comprise one or more of up to about 0.725% zirconium, up to about 0.11% yttrium, and up to about 0.11% hafnium.
